(19) United States
(12) Patent Application Publication
(10) Pub. No.: US 2006/0263122 A1
(43) Pub. Date: Nov. 23, 2006

(54) Image forming apparatus and image forming method with improved cleaning mechanism

(75) Inventor: Toshiharu Hachisuka, Tokyo (JP)

Correspondence Address: HARNESS, DICKEY & PIERCE, P.L.C., P.O. BOX 8910, RESTON, VA, 20195, US

(73) Assignee: Ricoh Co., Ltd.

(21) Appl. No.: 11/436,596

(22) Filed: May 19, 2006

(30) Foreign Application Priority Data
May 20, 2005 (JP) 2005-148443

(51) Int. Cl. G03G 15/20

(52) U.S. Cl. 399/327

(57) ABSTRACT

An image forming apparatus includes an image forming mechanism to form a toner image on a recording medium according to image data and a fixing mechanism to fix the toner image on the recording medium. The fixing mechanism includes a fixing member configured to apply heat to the toner image on the recording medium and a cleaning mechanism to clean a surface of the fixing member. The cleaning mechanism includes a cleaning member and a controller. The cleaning member removes contaminants from the surface of the fixing member. The controller controls the cleaning member to cause friction with the fixing member for a time period when a job starts to remove the contaminants from the surface of the fixing member and controls the cleaning member so as not to cause friction with the fixing member after the time period elapses.

### CROSS-REFERENCE TO RELATED APPLICATION

The present application is based on and claims priority to Japanese patent application No. 2005-148443 filed on May 20, 2005 in the Japan Patent Office, the entire contents of which are hereby incorporated herein by reference.

### BACKGROUND

1. Field

Example embodiments of the present invention generally relate to an image forming apparatus and/or an image forming method with an improved cleaning mechanism, such as one for removing contaminants including residual toner particles for example.

2. Description of the Background Art

A background electrophotographic image forming apparatus, such as a copying machine, a printer, or a facsimile machine, generally forms an electrostatic latent image on a photoconductor according to image data. The electrostatic latent image is visualized with toner to form a toner image on the photoconductor. The toner image is transferred onto a sheet and the sheet having the toner image is conveyed to a fixing unit in which heat and pressure are applied to the sheet to fix the toner image on the sheet.

The fixing unit includes a fixing roller for applying heat to the sheet having the toner image, a pressure roller for applying pressure to the sheet having the toner image, and a cleaning member for removing toner particles adhered to a surface of the fixing roller. The fixing roller and the pressure roller oppose to each other to form a nip between the fixing roller and the pressure roller, through which the sheet having the toner image is conveyed for a fixing operation.

During the fixing operation, toner particles of the toner image may be adhered to the surface of the fixing roller, and then may fall onto a surface of the pressure roller. The fallen toner particles may be adhered to a back side of a following sheet which is conveyed to the nip formed between the fixing roller and the pressure roller. To avoid this, the cleaning member contacts or slides on the surface of the fixing roller to remove the toner particles adhered to the surface of the fixing roller.

The background cleaning member is formed in a roller, blade, or web shape. The roller-shaped cleaning member rotates in accordance with rotation of the fixing roller during the fixing operation. Therefore, the roller-shaped cleaning member and the fixing roller may not easily wear, resulting in a long life of the roller-shaped cleaning member and the fixing roller, although the roller-shaped cleaning member may not provide increased cleaning performance.

The blade-shaped cleaning member slides on the surface of the fixing roller. Therefore, the blade-shaped cleaning member and the fixing roller may easily wear, resulting in a short life of the blade-shaped cleaning member and the fixing roller, although the blade-shaped cleaning member may provide increased cleaning performance.

The web-shaped cleaning member contacts the surface of the fixing roller, but may provide increased cleaning performance and a long life of the web-shaped cleaning member and the fixing roller. However, the web-shaped cleaning member may have a complex structure, resulting in a large size fixing unit.

### SUMMARY

This specification describes at least one embodiment of a novel image forming apparatus. In an example embodiment of the present invention, the novel image forming apparatus includes an image forming mechanism configured to form a toner image on a recording medium according to image data and a fixing mechanism configured to fix the toner image on the recording medium. The fixing mechanism includes a fixing member configured to apply heat to the toner image on the recording medium and a cleaning mechanism configured to clean a surface of the fixing member. The cleaning mechanism includes a cleaning member and a controller.

The cleaning member is configured to remove contaminants from the surface of the fixing member. The controller is configured to control the cleaning member to cause friction with the fixing member for a time period (which may be determinable and/or predetermined) when a job starts to remove the contaminants from the surface of the fixing member. The controller is also configured to control the cleaning member so as not to cause friction with the fixing member after the time period elapses.

This specification further describes at least one embodiment of a novel image forming method. In an example embodiment of the present invention, the novel image forming method includes forming a toner image on a recording medium according to image data, rotating a fixing member, controlling a cleaning member to cause friction with the fixing member for a time period (which may be determinable and/or predetermined) when a job starts to remove contaminants from a surface of the fixing member, controlling the cleaning member so as not to cause friction with the fixing member after the time period elapses, and fixing the toner image on the recording medium.

### BRIEF DESCRIPTION OF THE DRAWINGS

A more complete appreciation of the invention and the many attendant advantages thereof will be readily obtained as the same becomes better understood by reference to the following detailed description of example embodiments when considered in connection with the accompanying drawings, wherein:

FIG. 1 is a schematic view of an image forming apparatus according to an example embodiment of the present invention;

FIG. 2 is a schematic view of a fixing unit of the image forming apparatus shown in FIG. 1;

FIG. 3 is a schematic view of a cleaning unit of the fixing unit shown in FIG. 2;

FIG. 4 is a timing chart illustrating operations of the cleaning unit shown in FIG. 3;

FIG. 5 is a schematic view of a cleaning unit of the fixing unit shown in FIG. 2 according to another example embodiment of the present invention;

FIG. 6 is a timing chart illustrating operations of the cleaning unit shown in FIG. 5;

FIG. 7 is a schematic view of a cleaning unit of the fixing unit shown in FIG. 2 according to yet another example embodiment of the present invention;

FIG. 8 is a timing chart illustrating operations of the cleaning unit shown in FIG. 7;

FIG. 9 is a schematic view of a cleaning unit of the fixing unit shown in FIG. 2 according to yet another example embodiment of the present invention;

FIG. 10 is a timing chart illustrating operations of the cleaning unit shown in FIG. 9;

FIG. 11 is a schematic view of a cleaning unit of the fixing unit shown in FIG. 2 according to yet another example embodiment of the present invention;

FIG. 12 is a timing chart illustrating operations of the cleaning unit shown in FIG. 11;

FIG. 13 is a schematic view of a cleaning unit of the fixing unit shown in FIG. 2 according to yet another example embodiment of the present invention; and

FIG. 14 is a timing chart illustrating operations of the cleaning unit shown in FIG. 13.

### DETAILED DESCRIPTION OF EXAMPLE EMBODIMENTS

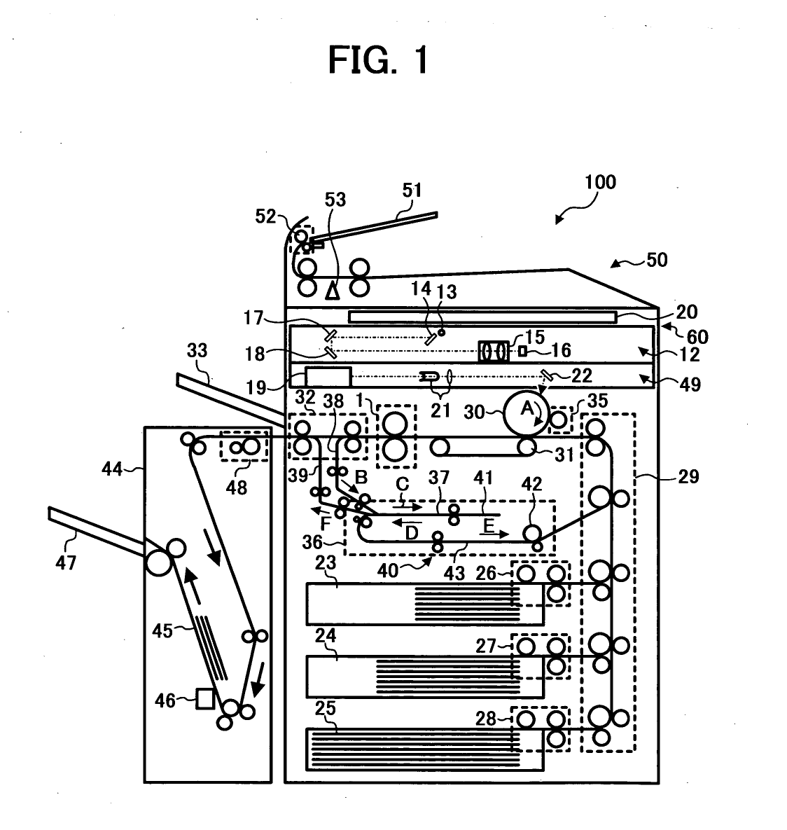

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, an image forming apparatus 100 according to an example embodiment of the present invention is explained.

As illustrated in FIG. 1, the image forming apparatus 100 includes an auto document feeder 50, a reader 60, a writer 49, a first paper tray 23, a second paper tray 24, a third paper tray 25, a first sheet feeder 26, a second sheet feeder 27, a third sheet feeder 28, a sheet conveyance unit 29, a photoconductor 30, a development unit 35, a conveyance belt 31, a fixing unit 1, an output unit 32, an output tray 33, an entrance conveyance path 38, a duplex unit 36, a reverse output conveyance path 39, and/or a finisher 44.

The image forming apparatus 100 functions as a copying machine, a printer, a facsimile machine, or the like which forms an image in an electrophotographic method.

The auto document feeder 50 includes an original tray 51, a feeding roller 52, and/or a reading sensor 53. An original (not shown) to be scanned is placed on the original tray 51. The feeding roller 52 feeds the original toward the reading sensor 53. The reading sensor 53 scans an image on a front side of the original while the original passes on the reading sensor 53 at a constant speed.

The reader 60 includes an exposure glass 20 and/or an optical scanning system 12. The optical scanning system 12 includes a lamp 13, a first mirror 14, a second mirror 17, a third mirror 18, a lens 15, and/or a CCD (charge-coupled device) image sensor 16. An original to be scanned is placed on the exposure glass 20. The lamp 13 emits light onto the original. The first mirror 14 deflects the light reflected by the original toward the second mirror 17. The second mirror 17 deflects the light deflected by the first mirror 14 toward the third mirror 18. The third mirror 18 deflects the light deflected by the second mirror 17 toward the lens 15. The lens 15 irradiates the light deflected by the third mirror 18 into the CCD image sensor 16. The CCD image sensor 16 converts the light into an electric signal.

The writer 49 includes a laser output unit 19, imaging lenses 21, and/or a mirror 22. Various image processing including correction and compression is performed on image data created by scanning an image on the original. The processed image data is stored into a memory (not shown). The laser output unit 19 outputs a laser beam toward the mirror 22 via the imaging lenses 21 according to the stored image data. The imaging lenses 21 correct the speed of the laser beam. The mirror 22 deflects the laser beam toward the photoconductor 30, which rotates in a rotating direction A, to form an electrostatic latent image on the photoconductor 30.

The first paper tray 23, the second paper tray 24, and/or the third paper tray 25 load sheets. The first sheet feeder 26, the second sheet feeder 27, or the third sheet feeder 28 feeds a sheet from the first paper tray 23, the second paper tray 24, or the third paper tray 25 toward the sheet conveyance unit 29. The sheet conveyance unit 29 further feeds the sheet toward the photoconductor 30.

The development unit 35 visualizes the electrostatic latent image formed on the photoconductor 30 with toner to form a toner image. The toner image is transferred onto the sheet while the conveyance belt 31 conveys the sheet at a speed similar to a rotating speed of the photoconductor 30 toward the fixing unit 1. The fixing unit 1 fixes the toner image on the sheet and feeds the sheet toward the output unit 32. The output unit 32 outputs the sheet onto the output tray 33.

The auto document feeder 50, the reader 60, the writer 49, the photoconductor 30, the development unit 35, and/or the conveyance belt 31 form an image forming mechanism for forming a toner image on a sheet according to image data.

To form a toner image on another side (e.g., a back side) of the sheet, a path switching nail (not shown) is switched to send the sheet toward the duplex unit 36 in a direction B via the entrance conveyance path 38 instead of sending the sheet toward the output tray 33. The duplex unit 36 includes a reverse unit 37, a switchback conveyance path 41, an intermediate conveyance path 43, intermediate feeding rollers 40, and/or an exit feeding roller 42.

In the duplex unit 36, the sheet is conveyed in a direction C to the reverse unit 37, and then stops on the switchback conveyance path 41. A switchback feeder (not shown) feeds the sheet in a direction D. A reverse switching nail (not shown) guides the sheet downward to the intermediate conveyance path 43. The intermediate feeding rollers 40 and the exit feeding roller 42 driven by a driver (not shown), for example, a motor, feed the sheet in a direction E toward the sheet conveyance unit 29. A toner image formed on the photoconductor 30 is transferred onto the back side of the sheet, and then the sheet is output onto the output tray 33.

To output the sheet with the toner image facing down, the reverse switching nail is switched to guide the sheet reversed in the reverse unit 37 in a direction F toward the reverse output conveyance path 39 instead of the intermediate conveyance path 43. The sheet is output onto the output tray 33 with the toner image facing down via the output unit 32.

The finisher 44 includes a punch unit 48, a stacking tray 45, a stapler 46, and/or a finisher output tray 47. The sheet may be sent into the finisher 44 by using an output switching nail (not shown). Namely, the sheet may be output either onto the output tray 33 or onto the finisher output tray 47 by switching the output switching nail. The punch unit 48 punches the sheet. The sheets to be stapled are stacked on the stacking tray 45. When all the sheets to be stapled are stacked on the stacking tray 45, the stapler 46 staples the sheets. The stapled sheets are output onto the finisher output tray 47.

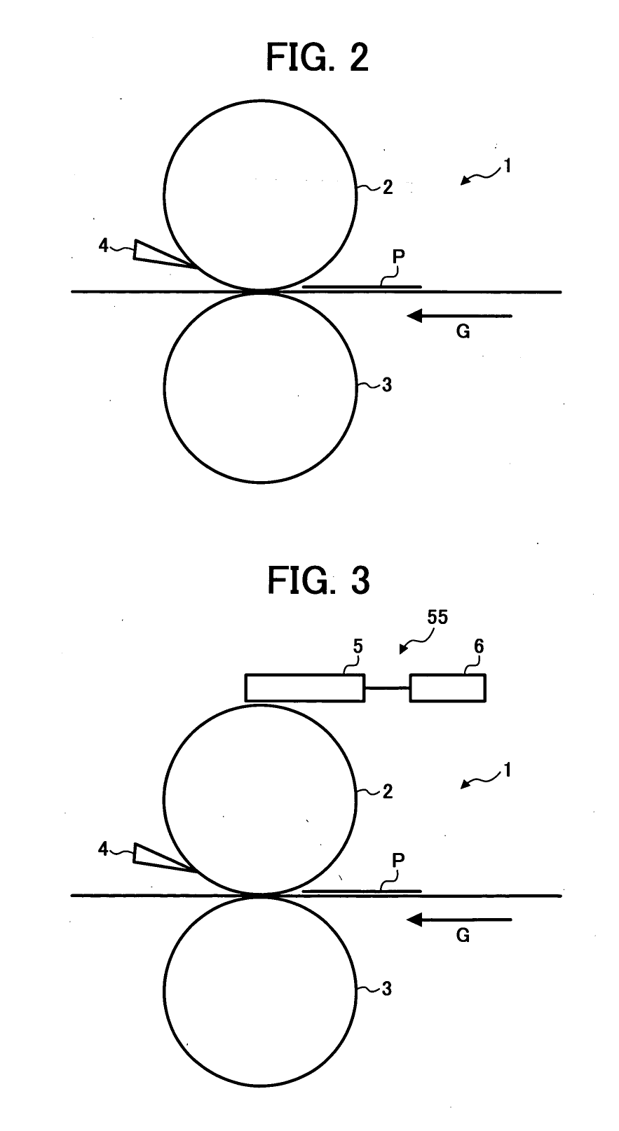

As illustrated in FIG. 2, the fixing unit 1 includes a fixing roller 2, a pressure roller 3, and/or a separator 4. The fixing roller 2 and the pressure roller 3 oppose to each other and respectively apply heat and pressure to a sheet P conveyed through a nip formed between the fixing roller 2 and the pressure roller 3. The separator 4 separates the sheet P conveyed in a direction G (e.g., a sheet conveyance direction) from the fixing roller 2.

The fixing roller 2 includes a silicone rubber layer (not shown) having a thickness of about 4 mm on a surface of an aluminum core (not shown) having a diameter of about φ50. A PFA (perfluoroalkoxy) tube (not shown) covers an uppermost surface of the fixing roller 2.

The pressure roller 3 includes a silicone rubber layer (not shown) having a thickness of about 2 mm on a surface of an aluminum core (not shown) having a diameter of about φ50. A PFA tube (not shown) covers an uppermost surface of the pressure roller 3. A halogen heater (not shown) is disposed inside each of the fixing roller 2 and the pressure roller 3. A temperature controller (not shown) controls the halogen heater.

A fixing motor (not shown) drives and rotates the fixing roller 2 for a fixing operation. The fixing roller 2 and the pressure roller 3 stop rotating during standby and start rotating when a job starts. The fixing roller 2 and the pressure roller 3 respectively apply heat and pressure to the sheet P which is conveyed through the nip formed between the fixing roller 2 and the pressure roller 3 to fix the toner image on the sheet P.

The separator 4 is disposed downstream of the fixing roller 2 in the sheet conveyance direction and near the nip formed between the fixing roller 2 and the pressure roller 3. However, the separator 4 may be provided for each of the fixing roller 2 and the pressure roller 3. Otherwise, the separator 4 may be provided for the pressure roller 3 and not for the fixing roller 2.

A fixing member and a pressing member formed in a belt-like shape may be used instead of the fixing roller 2 and the pressure roller 3. Specifically, the fixing unit 1 may include the fixing roller 2 and the belt-like shaped pressing member, the belt-like shaped fixing member and the pressure roller 3, or the belt-like shaped fixing member and the belt-like shaped pressing member.

As illustrated in FIG. 3, the fixing unit 1 further includes a cleaning unit 55 including a cleaning member 5 and/or a controller 6. The cleaning member 5 and the controller 6 are disposed near an upper portion of the fixing roller 2. The cleaning member 5 removes contaminants including residual toner particles from a surface of the fixing roller 2. The controller 6 controls the cleaning member 5.

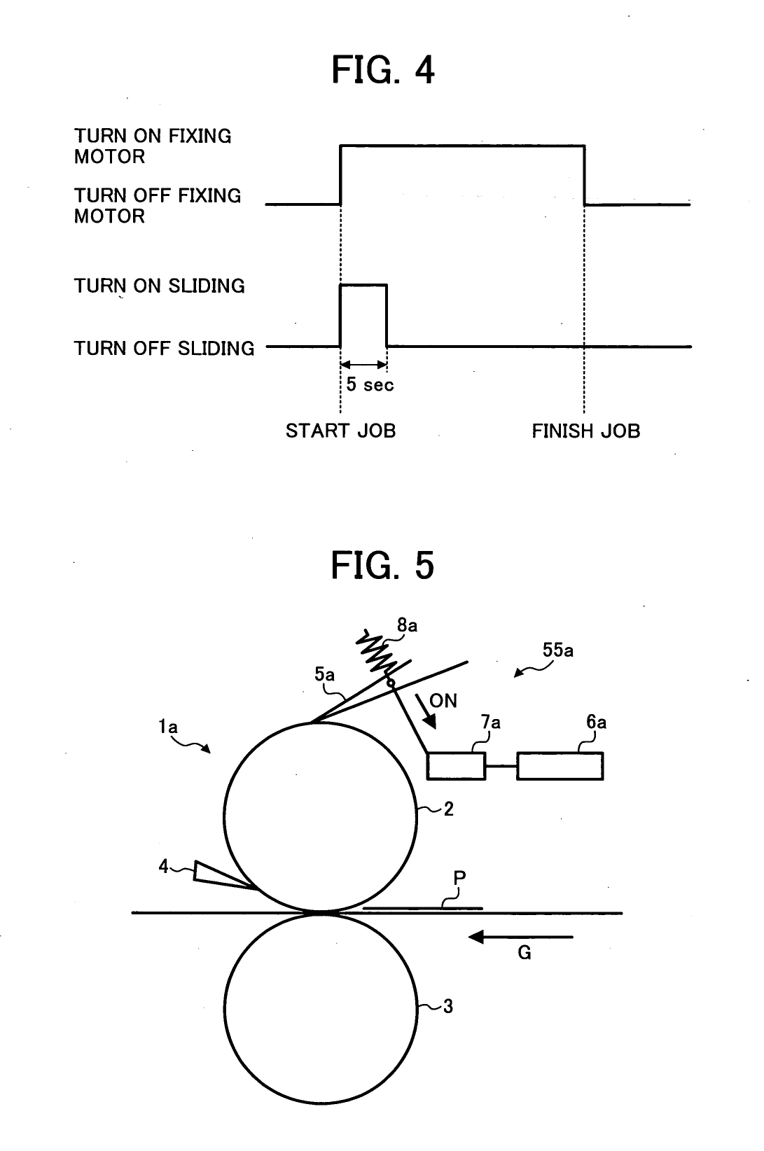

As illustrated in FIG. 4, when a job starts, the fixing motor is turned on. Simultaneously, the cleaning member 5 starts sliding on the surface of the fixing roller 2. When about 5 seconds elapse after the fixing motor starts rotating, the cleaning member 5 stops sliding on the surface of the fixing roller 2. The fixing motor continues rotating until the job is finished.

The cleaning member 5 slides on the surface of the fixing roller 2 when the job starts, and does not slide while the job is performed. Thus, when the job starts, toner particles, which may fall off the separator 4 or the like, may be removed, preventing the toner particles from adhering to the back side of the sheet P which faces the pressure roller 3. The cleaning member 5 does not slide on the surface of the fixing roller 2 while the job is performed. Thus, wear of the fixing roller 2 and the cleaning member 5 may be reduced, resulting in a longer life of the fixing roller 2 and the cleaning member 5.

FIG. 5 illustrates a fixing unit 1a according to another example embodiment of the present invention. As illustrated in FIG. 5, the fixing unit 1a includes the fixing roller 2, the pressure roller 3, the separator 4, and/or a cleaning unit 55a including a cleaning blade 5a, a solenoid 7a, a controller 6a, and/or a spring 8a.

The fixing roller 2 and the pressure roller 3 oppose to each other and respectively apply heat and pressure to a sheet P conveyed through the nip formed between the fixing roller 2 and the pressure roller 3. The separator 4 is disposed downstream of the fixing roller 2 in the sheet conveyance direction and near the nip formed between the fixing roller 2 and the pressure roller 3, and separates the sheet P conveyed in the direction G from the fixing roller 2.

The cleaning blade 5a, the solenoid 7a, the spring 8a, and the controller 6a are disposed near the upper portion of the fixing roller 2. The cleaning blade 5a contacts and separates from the surface of the fixing roller 2 to remove contaminants including residual toner particles from the surface of the fixing roller 2. The solenoid 7a causes the cleaning blade 5a to contact the surface of the fixing roller 2. The controller 6a controls the solenoid 7a. The spring 8a causes the cleaning blade 5a to separate from the surface of the fixing roller 2. When the solenoid 7a is turned on, a head of the cleaning blade 5a contacts and slides on the surface of the fixing roller 2 to remove toner particles adhered to the surface of the fixing roller 2.

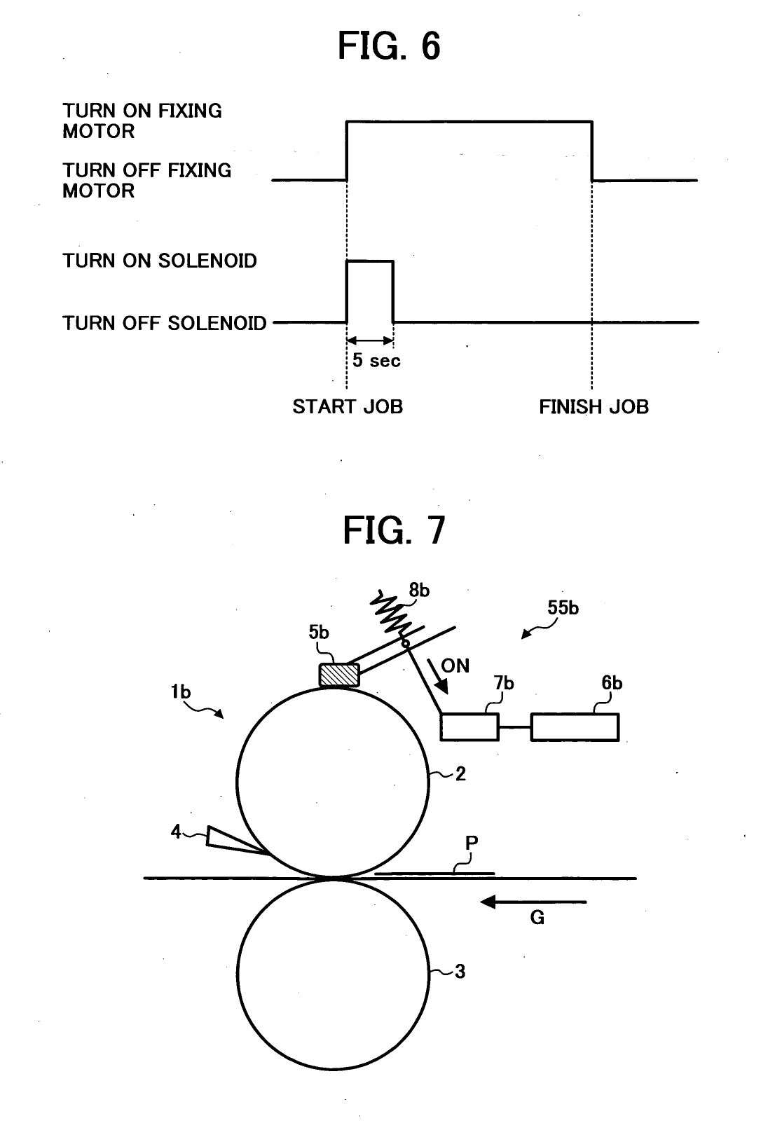

As illustrated in FIG. 6, when a job starts, the fixing motor is turned on. Simultaneously, the solenoid 7a is turned on to cause the cleaning blade 5a to contact and slide on the surface of the fixing roller 2. The cleaning blade 5a cleans the surface of the fixing roller 2 for about 5 seconds. When about 5 seconds elapse, the cleaning blade 5a separates from the surface of the fixing roller 2 and does not clean the surface of the fixing roller 2 until the job is finished.

FIG. 7 illustrates a fixing unit 1b according to yet another example embodiment of the present invention. As illustrated in FIG. 7, the fixing unit 1b includes the fixing roller 2, the pressure roller 3, the separator 4, and/or a cleaning unit 55b including a felt pad 5b, a solenoid 7b, a controller 6b, and/or a spring 8b.

The fixing roller 2 and the pressure roller 3 oppose to each other and respectively apply heat and pressure to a sheet P conveyed through the nip formed between the fixing roller 2 and the pressure roller 3. The separator 4 is disposed downstream of the fixing roller 2 in the sheet conveyance direction and near the nip formed between the fixing roller 2 and the pressure roller 3, and separates the sheet P conveyed in the direction G from the fixing roller 2.

The felt pad 5b, the solenoid 7b, the spring 8b, and the controller 6b are disposed near the upper portion of the fixing roller 2. The felt pad 5b contacts and separates from the surface of the fixing roller 2 to remove contaminants including residual toner particles from the surface of the fixing roller 2. The solenoid 7b causes the felt pad 5b to contact the surface of the fixing roller 2. The controller 6b controls the solenoid 7b. The spring 8b causes the felt pad 5b to separate from the surface of the fixing roller 2. When the solenoid 7b is turned on, a head of the felt pad 5b contacts and slides on the surface of the fixing roller 2 to remove toner particles adhered to the surface of the fixing roller 2.

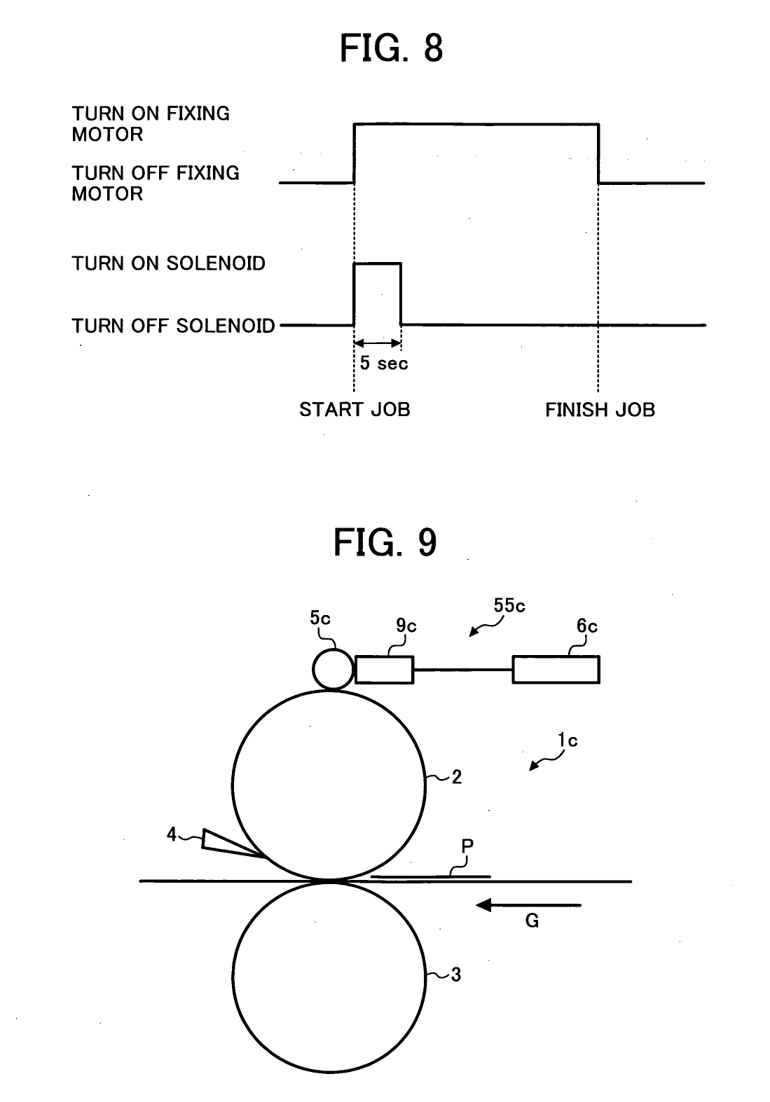

As illustrated in FIG. 8, when a job starts, the fixing motor is turned on. Simultaneously, the solenoid 7b is turned on to cause the felt pad 5b to contact and slide on the surface of the fixing roller 2. The felt pad 5b cleans the surface of the fixing roller 2 for about 5 seconds. When about 5 seconds elapse, the felt pad 5b separates from the surface of the fixing roller 2 and does not clean the surface of the fixing roller 2 until the job is finished.

The felt pad 5b contacting the surface of the fixing roller 2 may remove toner particles adhered to the surface of the fixing roller 2. Fibers of the felt pad 5b grab the toner particles. Thus, the toner particles may not remain on the surface of the fixing roller 2 when the felt pad 5b separates from the surface of the fixing roller 2.

FIG. 9 illustrates a fixing unit 1c according to yet another example embodiment of the present invention. As illustrated in FIG. 9, the fixing unit 1c includes the fixing roller 2, the pressure roller 3, the separator 4, and/or a cleaning unit 55c including a cleaning roller 5c, a controller 6c, and/or a brake 9c.

The fixing roller 2 and the pressure roller 3 oppose to each other and respectively apply heat and pressure to a sheet P conveyed through the nip formed between the fixing roller 2 and the pressure roller 3. The separator 4 is disposed downstream of the fixing roller 2 in the sheet conveyance direction and near the nip formed between the fixing roller 2 and the pressure roller 3, and separates the sheet P conveyed in the direction G from the fixing roller 2.

The cleaning roller 5c, the brake 9c, and the controller 6c are disposed near the upper portion of the fixing roller 2. The cleaning roller 5c rotates to remove contaminants including residual toner particles from the surface of the fixing roller 2. The cleaning roller 5c includes a sponge roller (not shown) having a diameter of about φ14 and a surface layer (not shown) including a PFA tube having a thickness of about 20 μm and covering the sponge roller. Positions of shafts of the fixing roller 2 and the cleaning roller 5c are fixed and surfaces of the fixing roller 2 and the cleaning roller 5c are engaged in each other by about 1 mm.

The brake 9c is disposed in an end portion of the shaft of the cleaning roller 5c and stops the rotating cleaning roller 5c. When the brake 9c is turned on, the cleaning roller 5c, which rotates in accordance with rotation of the fixing roller 2, stops rotating. The cleaning roller 5c slides on the surface of the fixing roller 2 to remove toner particles adhered to the surface of the fixing roller 2. The controller 6c controls the brake 9c.

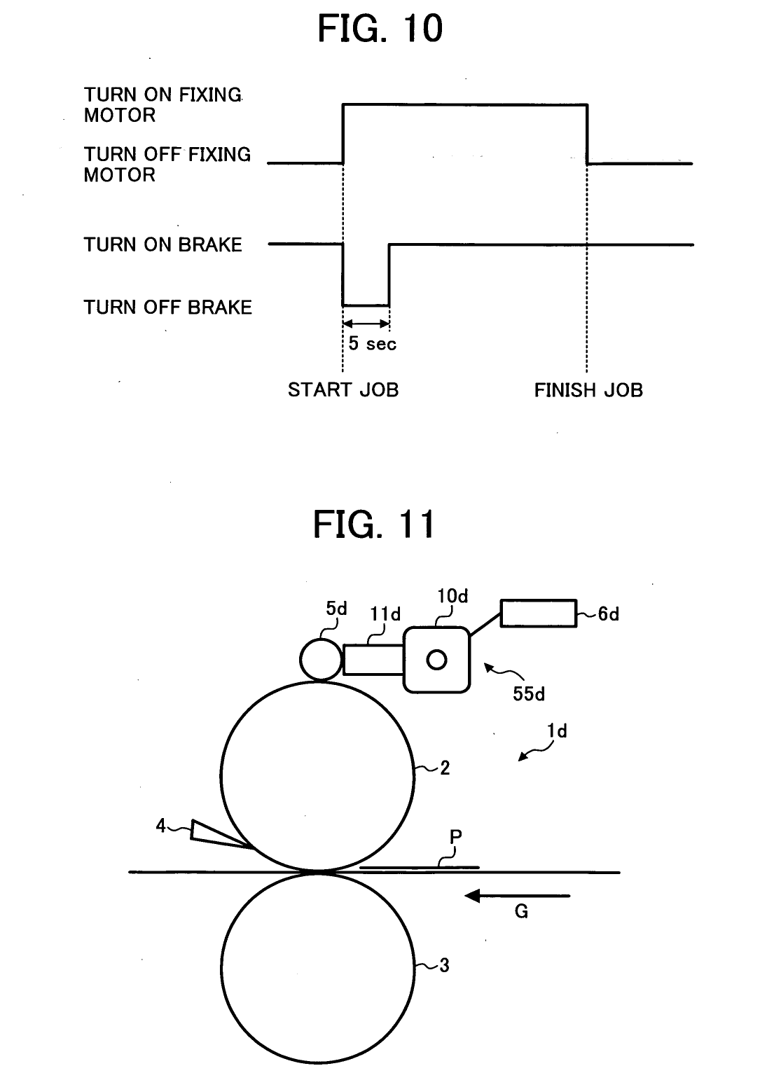

As illustrated in FIG. 10, when a job starts, the fixing motor is turned on. Simultaneously, the cleaning roller 5c starts sliding on the surface of the fixing roller 2. Specifically, the brake 9c is turned on for about 5 seconds when the job starts. Thus, the cleaning roller 5c slides on the surface of the fixing roller 2 to clean the surface of the fixing roller 2. When about 5 seconds elapse, the cleaning roller 5c rotates in accordance with rotation of the fixing roller 2 and does not clean the surface of the fixing roller 2 until the job is finished.

When the job starts, the cleaning roller 5c stops rotating and slides on the surface of the fixing roller 2 to remove toner particles adhered to the surface of the fixing roller 2. The cleaning roller 5c rotates in accordance with rotation of the fixing roller 2 and does not slide on the surface of the fixing roller 2 while the job is performed. Thus, wear of the fixing roller 2 and the cleaning roller 5c may be reduced, resulting in a longer life of the fixing roller 2 and the cleaning roller 5c. The cleaning roller 5c may not move to contact and separate from the surface of the fixing roller 2, resulting in a simple structure of the cleaning unit 55c and preventing toner particles from falling onto the surface of the fixing roller 2.

FIG. 11 illustrates a fixing unit 1d according to yet another example embodiment of the present invention. As illustrated in FIG. 11, the fixing unit 1d includes the fixing roller 2, the pressure roller 3, the separator 4, and/or a cleaning unit 55d including a cleaning roller 5d, a controller 6d, a cleaning roller driving motor 10d, and/or a clutch 11d.

The fixing roller 2 and the pressure roller 3 oppose to each other and respectively apply heat and pressure to a sheet P conveyed through the nip formed between the fixing roller 2 and the pressure roller 3. The separator 4 is disposed downstream of the fixing roller 2 in the sheet conveyance direction and near the nip formed between the fixing roller 2 and the pressure roller 3, and separates the sheet P conveyed in the direction G from the fixing roller 2.

The cleaning roller 5d, the cleaning roller driving motor 10d, the clutch 11d, and the controller 6d are disposed near the upper portion of the fixing roller 2. The cleaning roller 5d rotates to remove contaminants including residual toner particles from the surface of the fixing roller 2. The cleaning roller 5d includes a sponge roller (not shown) having a diameter of about φ14 and a surface layer (not shown) including a PFA tube having a thickness of about 20 μm and covering the sponge roller. Positions of shafts of the fixing roller 2 and the cleaning roller 5d are fixed and surfaces of the fixing roller 2 and the cleaning roller 5d are engaged in each other by about 1 mm.

The cleaning roller driving motor 10d is disposed in an end portion of the shaft of the cleaning roller 5d and drives the cleaning roller 5d at a constant number of rotations. When the cleaning roller driving motor 10d is turned on, the cleaning roller 5d rotates at a linear velocity slower than a linear velocity of the fixing roller 2. The cleaning roller 5d slides on the surface of the fixing roller 2 to remove toner particles adhered to the surface of the fixing roller 2. For example, when the fixing roller 2 rotates at a linear velocity of about 200 mm/sec, the cleaning roller 5d rotates at a linear velocity of about 165 mm/sec. The controller 6d controls the cleaning roller driving motor 10d. The clutch 11d connects and disconnects the cleaning roller driving motor 10d to and from the cleaning roller 5d.

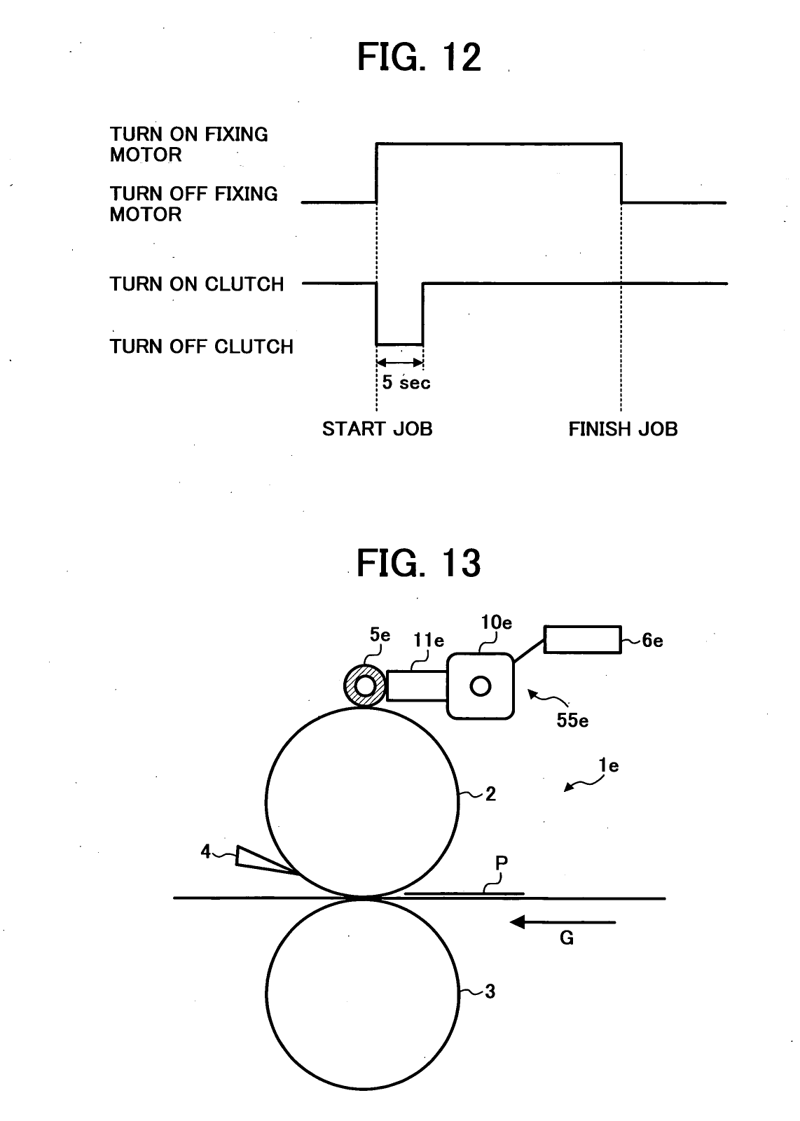

As illustrated in FIG. 12, when a job starts, the fixing motor is turned on. Simultaneously, the cleaning roller 5d starts sliding on the surface of the fixing roller 2. Specifically, the cleaning roller driving motor 10d is turned on for about 5 seconds when the job starts. Thus, the cleaning roller 5d slides on the surface of the fixing roller 2 to clean the surface of the fixing roller 2. When about 5 seconds elapse, the cleaning roller 5d rotates in accordance with rotation of the fixing roller 2 and does not clean the surface of the fixing roller 2 until the job is finished.

When the job starts, the cleaning roller 5d is driven to rotate at the linear velocity different from the linear velocity of the fixing roller 2 so as to slide on the surface of the fixing roller 2 to remove toner particles adhered to the surface of the fixing roller 2. The cleaning roller 5d rotates in accordance with rotation of the fixing roller 2 and does not slide on the surface of the fixing roller 2 while the job is performed. Thus, wear of the fixing roller 2 and the cleaning roller 5d may be reduced, resulting in a longer life of the fixing roller 2 and the cleaning roller 5d.

The cleaning roller 5d may not move to contact and separate from the surface of the fixing roller 2, resulting in a simple structure of the cleaning unit 55d and preventing toner particles from falling onto the surface of the fixing roller 2. When cleaning the surface of the fixing roller 2, the cleaning roller 5d does not stop rotating and rotates at the linear velocity different from the linear velocity of the fixing roller 2. Thus, toner particles may not intensively adhere to a certain part on the surface of the cleaning roller 5d in a circumferential direction of the cleaning roller 5d, but may uniformly adhere to the surface of the cleaning roller 5d, resulting in an even longer life of the cleaning roller 5d.

FIG. 13 illustrates a fixing unit 1e according to yet another example embodiment of the present invention. As illustrated in FIG. 13, the fixing unit 1e includes the fixing roller 2, the pressure roller 3, the separator 4, and a cleaning unit 55e including a cleaning felt roller 5e, a controller 6e, a cleaning roller driving motor 10e, and a clutch 11e.

The fixing roller 2 and the pressure roller 3 oppose to each other and respectively apply heat and pressure to a sheet P conveyed through the nip formed between the fixing roller 2 and the pressure roller 3. The separator 4 is disposed downstream of the fixing roller 2 in the sheet conveyance direction and near the nip formed between the fixing roller 2 and the pressure roller 3, and separates the sheet P conveyed in the direction G from the fixing roller 2.

The cleaning felt roller 5e, the cleaning roller driving motor 10e, the clutch 11e, and the controller 6e are disposed near the upper portion of the fixing roller 2. The cleaning felt roller 5e rotates to remove contaminants including residual toner particles from the surface of the fixing roller 2. The cleaning felt roller 5e has a diameter of about φ14, for example. A spring (not shown) presses the cleaning felt roller 5e toward the fixing roller 2.

The cleaning roller driving motor 10e is disposed in an end portion of a shaft of the cleaning felt roller 5e and drives the cleaning felt roller 5e at a constant number of rotations. When the cleaning roller driving motor 10e is turned on, the cleaning felt roller 5e rotates at a linear velocity slower than a linear velocity of the fixing roller 2. The cleaning felt roller 5e slides on the surface of the fixing roller 2 to remove toner particles adhered to the surface of the fixing roller 2. For example, when the fixing roller 2 rotates at a linear velocity of about 200 mm/sec, the cleaning felt roller 5e rotates at a linear velocity of about 165 mm/sec. The controller 6e controls the cleaning roller driving motor 10e. The clutch 11e connects and disconnects the cleaning roller driving motor 10e to and from the cleaning felt roller 5e.

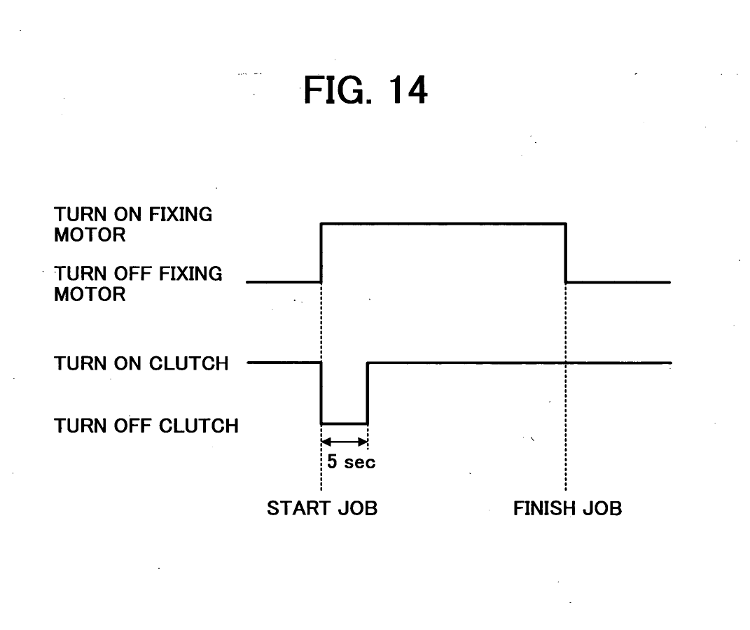

As illustrated in FIG. 14, when a job starts, the fixing motor is turned on. Simultaneously, the cleaning felt roller 5e starts sliding on the surface of the fixing roller 2. Specifically, the cleaning roller driving motor 10e is turned on for about 5 seconds when the job starts. Thus, the cleaning felt roller 5e slides on the surface of the fixing roller 2 to clean the surface of the fixing roller 2. When about 5 seconds elapse, the cleaning felt roller 5e rotates in accordance with rotation of the fixing roller 2 and does not clean the surface of the fixing roller 2 until the job is finished.

The cleaning felt roller 5e sliding on the surface of the fixing roller 2 may remove toner particles adhered to the surface of the fixing roller 2. Fibers of the cleaning felt roller 5e grab the toner particles. Thus, the toner particles may not be transferred onto the surface of the fixing roller 2 when the cleaning felt roller 5e rotates in accordance with rotation of the fixing roller 2.

The present invention has been described above with reference to specific embodiments. Note that the present invention is not limited to the details of the embodiments described above, but various modifications and improvements are possible without departing from the spirit and scope of the invention. It is therefore to be understood that within the scope of the appended claims, the present invention may be practiced otherwise than as specifically described herein. For example, elements and/or features of different illustrative embodiments may be combined with each other and/or substituted for each other within the scope of the present invention and appended claims.

What is claimed is:

1. An image forming apparatus, comprising:
an image forming mechanism to form a toner image on a recording medium according to image data; and
a fixing mechanism to fix the toner image on the recording medium and including,
a fixing member to apply heat to the toner image on the recording medium, and
a cleaning mechanism to clean a surface of the fixing member and including,
a cleaning member to remove contaminants from the surface of the fixing member, and
a controller to control the cleaning member to cause friction with the fixing member for a time period when a job starts to remove the contaminants from the surface of the fixing member and to control the cleaning member so as not to cause friction with the fixing member after the time period elapses.

2. The image forming apparatus according to claim 1,
wherein the controller stops rotating the cleaning member for the time period when the job starts to cause friction between the cleaning member and the fixing member, and
wherein the controller rotates the cleaning member in accordance with rotation of the fixing member after the time period elapses, so as not to cause friction between the cleaning member and the fixing member.

3. The image forming apparatus according to claim 1,
wherein the controller rotates the cleaning member at a linear velocity different from a linear velocity of the rotating fixing member for the time period when the job starts to cause friction between the cleaning member and the fixing member, and
wherein the controller rotates the cleaning member in accordance with rotation of the fixing member after the time period elapses, so as not to cause friction between the cleaning member and the fixing member.

4. The image forming apparatus according to claim 1,
wherein the cleaning member includes felt.

5. The image forming apparatus according to claim 1,
wherein the cleaning member includes a felt pad and the controller contacts the cleaning member to the surface of the fixing member for the time period when the job starts to cause friction between the cleaning member and the fixing member, and
wherein the controller separates the cleaning member from the surface of the fixing member after the time period elapses, so as not to cause friction between the cleaning member and the fixing member.

6. The image forming apparatus according to claim 1,
wherein the cleaning member is formed in a blade-like shape and the controller contacts the cleaning member to the surface of the fixing member for the time period when the job starts to cause friction between the cleaning member and the fixing member, and
wherein the controller separates the cleaning member from the surface of the fixing member after the time period elapses, so as not to cause friction between the cleaning member and the fixing member.

7. The image forming apparatus according to claim 1, wherein the cleaning member is useable to remove contaminants including residual toner particles.

8. An image forming method, comprising:
forming a toner image on a recording medium according to image data;
rotating a fixing member;
controlling a cleaning member to cause friction with the fixing member for a time period when a job starts to remove contaminants from a surface of the fixing member;
controlling the cleaning member so as not to cause friction with the fixing member after the time period elapses; and
fixing the toner image on the recording medium.

9. The image forming method of claim 8, wherein the cleaning member is controlled to cause friction with the fixing member for a time period when a job starts, to remove contaminants including residual toner particles from the surface of the fixing member.

10. The image forming method according to claim 8,
wherein the cleaning member is controlled to stop rotating for the time period when the job starts to cause friction between the cleaning member and the fixing member, and
wherein the cleaning member is rotated in accordance with rotation of the fixing member after the time period elapses, so as not to cause friction between the cleaning member and the fixing member.

11. The image forming method according to claim 8,
wherein the cleaning member is rotated at a linear velocity different from a linear velocity of the rotating fixing member for the time period when the job starts to cause friction between the cleaning member and the fixing member, and
wherein the cleaning member is rotated in accordance with rotation of the fixing member after the time period elapses, so as not to cause friction between the cleaning member and the fixing member.

12. A cleaning apparatus to clean a surface of a fixing device to fix toner in an image forming apparatus, comprising:
a cleaning member to remove contaminants from a surface of the fixing device; and
a controller to control the cleaning member to cause friction with the fixing device for a time period when a job starts to remove the contaminants from the surface of the fixing device and to control the cleaning member so as not to cause friction with the fixing device after the time period elapses.

13. The cleaning apparatus according to claim 12,
wherein the cleaning member includes felt.

14. The cleaning apparatus according to claim 12,
wherein the cleaning member includes a felt pad and the controller contacts the cleaning member to the surface of the fixing device for the time period when the job starts to cause friction between the cleaning member and the fixing device, and
wherein the controller separates the cleaning member from the surface of the fixing device after the time period elapses, so as not to cause friction between the cleaning member and the fixing device.

15. The cleaning apparatus according to claim 12,
wherein the cleaning member is formed in a blade-like shape and the controller contacts the cleaning member to the surface of the fixing device for the time period when the job starts to cause friction between the cleaning member and the fixing device, and
wherein the controller separates the cleaning member from the surface of the fixing device after the time period elapses, so as not to cause friction between the cleaning member and the fixing device.

16. The cleaning apparatus according to claim 12, wherein the cleaning member is useable to remove contaminants including residual toner particles.
